(19) United States
(12) Patent Application Publication
(10) Pub. No.: US 2011/0029345 A1
(43) Pub. Date: Feb. 3, 2011

(54) Managing Planning of Component Requirements

(76) Inventor: Stefan Kienzle, St. Leon-Rot (DE)

Correspondence Address: FISH & RICHARDSON, P.C., PO BOX 1022, MINNEAPOLIS, MN, 55440-1022, US

(21) Appl. No.: 12/533,207

(22) Filed: Jul. 31, 2009

(51) Int. Cl. G06Q 10/00; G06F 17/00

(52) U.S. Cl. 705/8; 700/107; 700/105

(57) ABSTRACT

Component planning for a product manufacturing enterprise having a central computer device and respective local manufacturing computer devices. A BOM for product types manufactured at the multiple manufacturing plants is maintained in the central computer device, defining that each of the product types belongs to a platform design and includes at least (i) a first component common to all of the products types and (ii) a second component not common to all of the product types. First-component data and second-component data from the BOM are forwarded to a central planning unit in the central computer device for generating a central plan for the first component, and to local planning units in the manufacturing computer devices configured to generate a local plan for the second component used by the corresponding manufacturing plant, respectively. The components are purchased according to the central plan and the local plan.

### TECHNICAL FIELD

This document relates to planning of production and material requirements in a manufacturing environment.

### BACKGROUND

A manufacturer can use production planning to determine the type and number of products to produce which can be based on sales orders. The manufacturer can use material requirements planning to plan the type and quantity of each of the components (e.g., materials or parts) needed for a manufacturing and purchasing process for the production of the product types. The determination of the material requirements for the product types can be made available to the manufacturing plants responsible for the production of the product types and to a product manufacturing enterprise system responsible for the management and purchasing of the required components. The manufacturer can implement the product manufacturing enterprise system such that the system can perform material requirements planning in a centralized location (e.g., the manufacturer's headquarters) or in a decentralized location (e.g., each manufacturing plant).

### SUMMARY

In a first aspect, a computer program product is tangibly embodied in a computer-readable storage medium and includes instructions that when executed by a processor perform a method for managing planning of component requirements. The method includes providing a system for a product manufacturing enterprise having a central location and multiple manufacturing plants at different locations. The system includes a central computer device at the central location and respective manufacturing computer devices for each of the multiple manufacturing plants. The method includes maintaining, in the central computer device, a BOM for a plurality of product types manufactured at the multiple manufacturing plants, the BOM defining that each of the product types belongs to a platform design and includes at least (i) a first component common to all of the products types and (ii) a second component not common to all of the product types. The method includes forwarding, from the BOM, first-component data regarding the first component of the product types to a central planning unit in the central computer device, the central planning unit being configured to generate a central plan for managing planning for the first component. The method includes forwarding, from the BOM, second-component data regarding the second component of each of the product types to local planning units in the manufacturing computer devices, each of the local planning units being configured to generate a local plan for managing planning for the second component used by the corresponding manufacturing plant. The method includes causing the first and second components to be purchased for use by the product manufacturing enterprise according to the central plan and the local plan.

Implementations can include any or all of the following features. The method can further include applying a filter in the central computer device to select the first-component data and the second-component data from the BOM. The method can further include providing the central plan to the manufacturing computer devices, wherein each of the manufacturing computer devices combines the central plan with the local plan from the manufacturing computer device. The central computer device can push the central plan to at least one of the manufacturing computer devices. At least one of the manufacturing computer devices can pull the central plan from the central computer device. The central computer device can include a service-oriented architecture, and the central plan can be provided to the manufacturing computer devices using a service in the service-oriented architecture. Each of the manufacturing computer devices can generate an object using the central plan and the local plan, and can use the object in executing manufacturing of at least one of the product types by the manufacturing computer system. Engineering changes can be received from at least one of the central planning unit and the manufacturing planning unit, and the object can be modified according to the engineering changes.

In a second aspect, a computer program product is tangibly embodied in a computer-readable storage medium and includes instructions that when executed by a processor perform a method for managing planning of component requirements. The method includes providing a system for a product manufacturing enterprise having a central location and multiple manufacturing plants at different locations. The system includes a central computer device at the central location and respective manufacturing computer devices for each of the multiple manufacturing plants. The method includes maintaining, in the central computer device, a BOM for at least one product type manufactured at the multiple manufacturing plants, the BOM defining that the product type comprises at least (i) a first component delivered from a first vendor and (ii) a second component delivered from a second vendor. The method includes associating a first plant of the manufacturing plants with the first vendor based on a location of the first vendor and a geographic-allocation criterion. The method includes associating a second plant of the manufacturing plants with the second vendor based on a location of the second vendor and the geographic-allocation criterion. The method includes forwarding, from the BOM, first-component data regarding the first component to a first local planning unit in the manufacturing computer device of the first plant, the first local planning unit being configured to generate a first central plan for managing planning for the first component on behalf of all of the manufacturing plants. The method includes forwarding, from the BOM, second-component data regarding the second component to a second local planning unit in the manufacturing computer device of the second plant, the second local planning unit being configured to generate a second central plan for managing planning for the second component on behalf of all of the manufacturing plants.

Implementations can include any or all of the following features. The geographic-allocation criterion can include that the first plant is selected for the first vendor because the first vendor is located geographically closer to the first plant than the second plant. The method can further include providing the BOM with geographical tags for the first-component data and the second-component data, the geographical tags representing the first and second plants, respectively. The BOM can include at least a first view representing the product type being manufactured at the first plant, and a second view representing the product type being manufactured at the second plant. The method can further include receiving, at the central computer device, the first and second central plans from the first and second planning units, respectively. The method can further include forwarding, from the central computer device and to each of the manufacturing computer devices of the first and second plants, first and second finished order objects configured for use by the first and second manufacturing computer devices, respectively, in executing production of the product type. The first finished order object can require the product type to be manufactured using a component for which the planning is managed by the manufacturing computer device of the second plant.

In a third aspect, a system includes a central computer device at a central location of a product manufacturing enterprise. The central computer device has stored therein a BOM defining a product manufactured by the product manufacturing enterprise as comprising at least first and second components. The system includes manufacturing computer devices connected to the central computer device and operated by manufacturing plants at different locations of the product manufacturing enterprise. The system includes planning units tangibly embodied in computer readable storage media distributed within the system. Each of the planning units is configured to generate a plan for managing planning for at least one of the first and second components. The system dynamically distributes, among the planning units and based on at least one criterion, the planning for the first and second components for manufacturing the product.

Implementations can include any or all of the following features. The criterion can include a factor of which of the manufacturing computer devices uses the respective first and second components. The criterion can include a geographic location factor. The geographic location factor can include that one of the planning units that is closest to a vendor for the first component shall perform the planning for the first component, and that one of the planning units that is closest to a vendor for the second component shall perform the planning for the second component. One of the planning units can be located in the central computer system.

The details of one or more implementations are set forth in the accompanying drawings and the description below. Other features and advantages will be apparent from the description and drawings, and from the claims.

### DESCRIPTION OF DRAWINGS

FIG. 1 is a block diagram of an exemplary product manufacturing enterprise system that performs material resource planning at a central location and at manufacturing plants.

FIG. 2 is a block diagram of another exemplary product manufacturing enterprise system that performs material resource planning at manufacturing plants.

FIG. 3 schematically illustrates an exemplary process for determining component procurement at a manufacturing plant level.

FIG. 4 is a flow chart of exemplary operations that can be performed to manage planning of component requirements.

FIG. 5 is a flow chart of exemplary operations that can be performed to manage planning of component requirements.

FIG. 6 is a block diagram of a computing system that can be used in connection with computer-implemented methods described in this document.

Like reference symbols in the various drawings indicate like elements.

### DETAILED DESCRIPTION

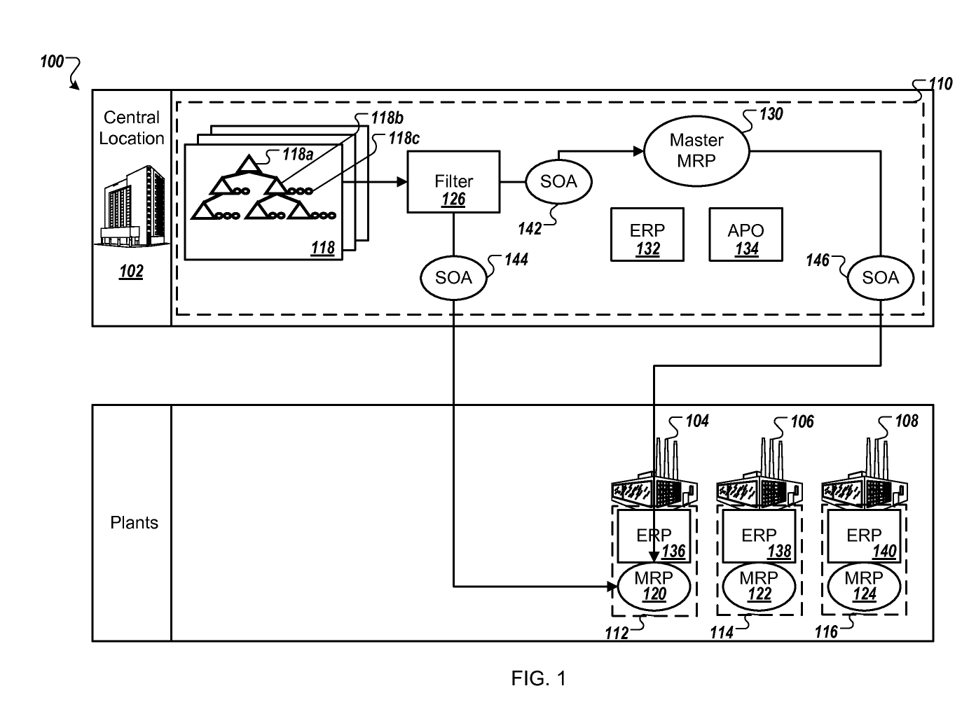

FIG. 1 is a block diagram of an exemplary product manufacturing enterprise system 100 that performs material resource planning at a central location 102 (e.g., a headquarters) and at manufacturing plants 104, 106, 108. In the example of FIG. 1, the central location 102 may perform enterprise management operations (e.g., corporate product planning and management, human resource management, etc.) while manufacturing plants 104, 106, 108 may perform manufacturing and/or assembly operations.

In some implementations, the enterprise (e.g., a company or corporation) may own and operate the manufacturing plants 104, 106, 108. In some implementations, the manufacturing plants 104, 106, 108 may be owned by a third party and operated by the enterprise. In some implementations, the enterprise may own the manufacturing plants 104, 106, 108 and a third party may operate them.

Referring to FIG. 1, the central location 102 can include a central computer device 110. The central computer device 110 can be configured for use in the enterprise management operations, and may include a bill of materials BOM (BOM) 118, a filter module 126, a master materials requirements planning (MRP) module 130, an enterprise resource planning (ERP) module 132 and an advanced planner and optimizer (APO) module 134. The BOM 118 can include a list of components (e.g., raw materials, sub-assemblies, intermediate assemblies, parts) needed to assemble and manufacture a finished product or a product type. The BOM 118 can include a component name, the quantities of each component needed to manufacture the finished product and the supply chain source for the component. For example, BOM 118 can be represented as a hierarchical structure with top level 118a representing the finished product, and lower levels (e.g., lower level 118b) representing sub-assemblies that may include the addition of components (e.g., components 118c). A BOM explosion breaks apart each assembly or sub-assembly listed in the BOM into its component parts. In some implementations, the product manufacturing enterprise system 100 can use integrated product and process engineering (e.g., iPPE by SAP AG) to maintain master data needed to create and maintain a BOM.

The product manufacturing enterprise system 100 can perform material requirements planning for a manufacturing or parts procurement process for the manufacture of a finished product. Material requirements planning can take into consideration existing enterprise stock levels, and existing purchase and production orders using defined planning rules. In the example of FIG. 1, the master MRP module 130 (e.g., SAP MRP software manufactured by SAP AG) can perform centralized material requirements planning for all enterprise manufactured finished products.

The product manufacturing enterprise system 100 can use enterprise resource planning to allow for open and consistent communication within and between all enterprise functions. The ERP module 132 (e.g., SAP ERP software manufactured by SAP AG) can provide enterprise resource planning for the central location 102.

The product manufacturing enterprise system 100 can use supply chain planning applications that can increase the system's overall knowledge of the supply chain and can also provide forecasting, planning and optimization functions for supply chain management. The APO module 134 (e.g., SAP APO software manufactured by SAP AG) can provide supply chain planning and management functions in the central location 102.

The central computer device 110 can implement a service oriented architecture (SOA). Interoperable services within the service orientated architecture can allow different applications included in the product manufacturing enterprise system 100 to exchange data with one another. The services can be accessible over an internal enterprise network or a network that can allow communication with applications outside of the internal enterprise network. The services can communicate by passing data from one service to another or by coordinating an activity between two services. The use of a service oriented architecture in the product manufacturing enterprise system 100 can allow for efficient and secure communication between system modules. For example, the central computing device 110 can use a service in the service oriented architecture to provide data from one module to another module in the central computing device 110. Also, the central computing device 110 can use a service in the service oriented architecture to provide data from one module in the central computing device 110 (e.g., master MRP module 130) to another module located in a manufacturing plant (e.g., MRP module 120 in manufacturing plant 104).

Manufacturing plants 104, 106, 108 can include one or more manufacturing computer devices 112, 114, 116, respectively. The computer device 112 can include a local MRP module 120 and a local ERP module 136, the computer device 114 can include a local MRP module 122 and a local ERP module 138, and computer device 116 can include a local MRP module 124 and a local ERP module 140. ERP modules 136, 138, 140 can provide enterprise resource planning for manufacturing plants 104, 106, 108 respectively.

The product manufacturing enterprise system 100 can use the master MRP module 130 as a central planning unit to plan the material requirements for a manufacturing or parts procurement process. Additionally, a manufacturing plant can use its local MRP module as a local planning unit to plan the material requirements for a manufacturing or parts procurement process performed at the manufacturing plant (e.g., procurement of components, parts or materials needed for the manufacture of the products at the specific manufacturing plant). The product manufacturing enterprise system 100 can use the master MRP module 130 together with each of the local MRP modules 120, 122, 124 in planning the material requirements for the manufacture of finished products at each of the manufacturing plants 104, 106, 108.

In some implementations, the product manufacturing enterprise system 100 may use a combination of common parts (e.g., a collection of parts used in the manufacture of a plurality of finished products) and specific parts (e.g., parts used for a small subset or only one of the plurality of finished products) to manufacture a finished product. The combination of common parts may be referred to as a platform. For example, a product manufacturing enterprise system may require the use of thousands of parts to assemble a finished automobile. The enterprise may use a platform design for the automobile in which the platform may include one thousand parts. The enterprise can use the one thousand common parts to manufacture a series of automobiles. Remaining specific parts may include optional accessories (e.g., a navigation system) that can be included in one or more particular automobiles.

In the product manufacturing enterprise system 100, the master MRP module 130 in the central computer device 110 at the central location 102 can perform centralized material requirements planning. The master MRP module 130 can be responsible for the planning and procurement of common materials and parts (e.g., the platform) used to assemble a plurality of products manufactured at one or more manufacturing plants (e.g., manufacturing plant 104). For example, and in contrast, the local MRP module 120 in the manufacturing computer device 112 can provide localized material requirements planning in the manufacturing plant 104 for the procurement of materials and parts that are specific to the products manufactured at the manufacturing plant 104. This can result in a distributed material requirements planning process.

Using a distributed material requirements planning process can balance the use of centralized planning processes with local manufacturing plant specific planning processes for material requirements planning. The processes can involve managing the master data for the BOM, the material requirements planning processes and the purchasing processes. In some implementations, the master MRP module 130 can perform a BOM explosion. The product manufacturing enterprise system 100 can use BOM explosions for material and parts procurement.

In some implementations, the central location 102 can consolidate purchasing for all manufactured product types, for example in instances where the central location is nearest the supplier of the purchased item. In some implementations, the purchasing of a specific material or part can be consolidated in the facility in closest proximity to the specific material or part supplier, for example in the central location or in a local plant. Purchasing consolidation can allow for volume discounts on purchased materials and parts. Purchasing consolidation can optimize the purchasing process using one purchase order to purchase a large quantity of a single part. In addition, purchasing consolidation can optimize the purchasing process because one individual can be responsible for the purchase orders, parts management and interaction with the parts vendor for a large quantity of parts. In the product manufacturing enterprise system 100, the central location 102 can be responsible for the planning and procurement of the common parts used in the platform design. Centralized common parts management can keep common parts used for a platform standardized for the platform.

In some implementations, a local MRP module (e.g., local MRP module 120) can perform a BOM explosion. The product manufacturing enterprise system 100 can use the local BOM explosions for material and parts procurement. The manufacturing plant (e.g., manufacturing plant 104) can locally manage the purchase of the specific materials and parts needed to manufacture the finished products assigned to the manufacturing plant (e.g., manufacturing plant 104). Local material requirements planning can result in improved manufacturing processes and product quality as the responsibility for the finished product is at a smaller, decentralized level closer to the physical manufacturing process that may have the best knowledge about the particular part.

The product manufacturing enterprise system 100 can use the filter module 126 to determine which components in the central hosted master data BOM 118 are common parts (e.g., used in a platform design) and which components in the BOM 118 are specific parts (e.g., used in a single finished product). The filter module 126 can provide the filtered master data as a BOM to the master MRP module 130 and the local MRP module 120.

In some implementations, the product manufacturing enterprise system 100 can maintain the master data as a flat list of components designated as either common components (e.g., parts associated with a platform design) or specific components (e.g., parts associated with a local manufacturing plant). In some implementations, the common components in the master data BOM 118 can be designated by the use of a flag signifying that they are common components. The master MRP module 130 can perform a BOM explosion on all BOMs for all manufacturing plants for all “common flagged” components. The master MRP module 130 can consolidate all of the identified common parts for parts procurement management.

In some implementations, the master data BOM 118 can include information (e.g., in the header) as to what components are managed centrally (e.g., common components) and what components are managed locally (e.g., specific components). The product manufacturing enterprise system 100 can send the master data, with the common components flagged, from the filter module 126 using service 142 in the SOA to the master MRP module 130. The master MRP module 130 can generate a central plan for managing the procurement of the common parts for all finished products manufactured by the enterprise. In some implementations, the filter module 126 may provide master data to the master MRP module 130 that includes only the common parts.

The product manufacturing enterprise system 100 can send the master data, with specific components flagged, from the filter module 126 using service 144 in the SOA to the local MRP module 120. The local MRP module 120 can generate a local plan for managing the procurement of the specific parts for the finished product manufactured by the manufacturing plant 104. In some implementations, the filter module 126 may provide master data to the local MRP module 130 that includes only the specific parts.

The central location 102 can provide a central plan generated by the master MRP module 130 in the central computer device 110 to the local MRP module 120 in the manufacturing computer device 112 using service 146 in the SOA. The central plan can be the result of a partial BOM explosion by the master MRP module 130 that includes only the common parts needed for the manufacture of the finished product. A local plan can be the result of a partial BOM explosion by the local MRP module 120 that includes only the specific parts needed for the manufacture of the finished product. The manufacturing computer device 112 can combine the central plan with the local plan resulting in a complete plan for the manufacture of and parts procurement for the finished product. The manufacturing plant 104 can manage the complete plan resulting in a complete order for a finished product. However, the central location 102 can manage the master data BOM 118 for the finished product. In some implementations, the manufacturing plant (e.g., manufacturing plant 104) can request (e.g., “pull”) the central plan from the central location 102. In some implementations, the central location 102 can send (e.g., “push”) the central plan to the manufacturing plant (e.g., manufacturing plant 104).

A manufacturing plant (e.g., manufacturing plant 104) can manage the complete orders for each finished product it manufactures. In some implementations, a complete planned order object can be stored in the manufacturing plant (e.g., manufacturing plant 104). The planned order object can include a list of common parts and specific parts used in the manufacture of the finished product. The manufacturing plant (e.g., manufacturing plant 104) can use the planned order object to manufacture the finished product. In some implementations, the manufacturing plant (e.g., manufacturing plant 104) can store the planned order objects in the manufacturing computer device (e.g., manufacturing computer device 112). In some implementations, the manufacturing plant (e.g., manufacturing plant 104) can store the planned order objects on a central computer device (e.g., central computer device 110) in a central location (e.g., central location 102). The manufacturing plant (e.g., manufacturing plant 104) can access the planned order objects when the manufacture of the finished product is performed.

In the product manufacturing enterprise system 100, changes to the manufactured finished products can occur prior to the manufacture of the finished product but after the receipt of the initial order for the product. For example, an engineering change notice can be introduced into the product manufacturing enterprise system 100 indicating the product order (e.g., using a product order number) and changes requested for the finished product. The changes may affect the common parts or the specific parts needed for the manufacture of the finished product.

In some implementations, the central location 102 can receive the engineering change notice. The central computer device 110 can update the master data for the BOM with the change. If the change affects a common part, the master MRP module 130 can perform a BOM explosion and generate an updated central plan to send to the local manufacturing plant responsible for manufacturing the finished product. If the change affects a specific part, the central computer device 110 can send the updated BOM to the manufacturing plant (e.g., manufacturing plant 104) responsible for manufacturing the finished product. For example, the local MRP module 120 can perform a BOM explosion and generate an updated local plan that can be incorporated into the central plan resulting in an updated complete order plan. For example, the central computer device 110 or the manufacturing computer device (e.g., manufacturing computer device 112) can incorporate the change into the planned order by modifying the order to include a new part, change an existing part or remove an existing part. The change can also be made to the planned order object to be reflected in the manufacture of the finished product.

In some implementations, an enterprise can use centralized material requirements planning at a central location for all manufactured products without the use of local material requirements planning in any of the enterprise's manufacturing plants. A complete planned order can be the result of a BOM explosion performed by a central material requirements planning module. The central location can consolidate the material and parts procurement processes by centrally managing the gross demand on the finished product and the parts stock level for the finished product. The manufacturing plant can manage the logistics execution (e.g., the assembly of the finished product). The central location can organize the purchasing of all components (e.g., common parts and specific parts) from suppliers. The central location can be responsible for the distribution of all components to the specific manufacturing plants.

In some implementations, an enterprise can use decentralized material requirements planning where each manufacturing plant can do local material requirements planning for the products it manufacturers without the use of centralized material requirements planning at a central location. A complete planned order can be the result of a BOM explosion performed by a local material requirements planning module in the manufacturing plant. The manufacturing plant can perform local material requirements planning with netting (e.g., cross demand minus stock level) where the stock level is in a physical location. Local material requirements planning can determine part volumes needed at the specific manufacturing plant for the manufacture of finished products. The central location can sum up part demands from all manufacturing plants. The central location can perform consolidated purchasing for all parts across all products and all manufacturing plants from the demands made at each of the manufacturing plants. The manufacturing plant can manage the logistics execution (e.g., the manufacture of the finished product). The central location can organize the purchasing of all components (e.g., common parts as well as specific parts) from suppliers. The central location can be responsible for the distribution of all parts to each specific manufacturing plant.

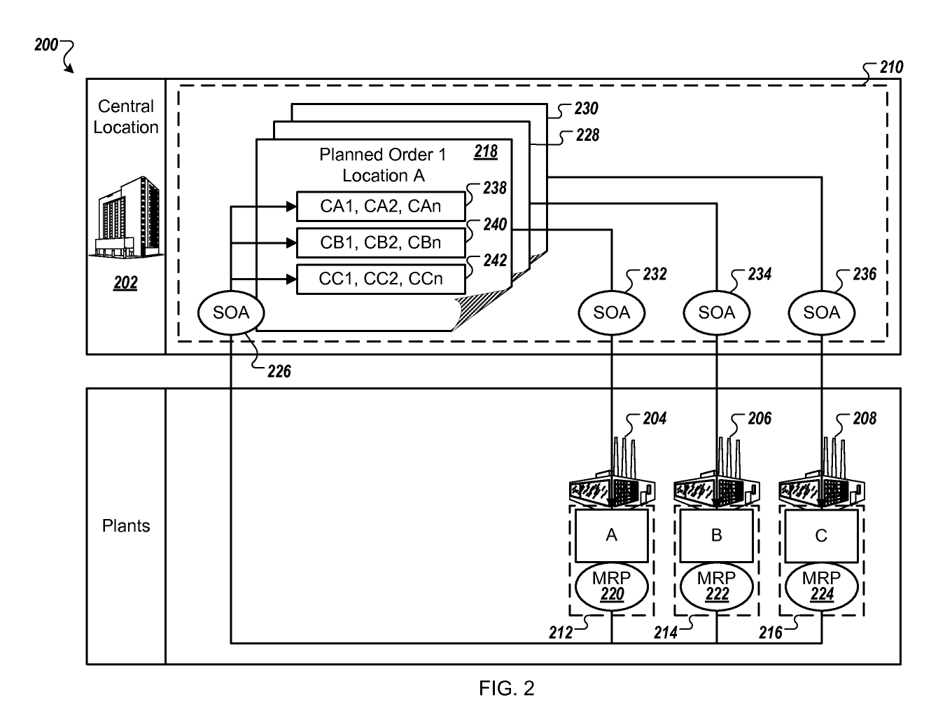

FIG. 2 is a block diagram of an another exemplary product manufacturing enterprise system 200 that performs material resource planning at manufacturing plants 204, 206, 208. The product manufacturing enterprise system 200 can include a central location 202 (e.g., a headquarters) and manufacturing plants 204, 206, 208 that are at different geographic locations. In the example of FIG. 2, the central location 102 may perform enterprise management operations (e.g., corporate product planning and management, human resource management, etc.) while manufacturing plants 104, 106, 108 may perform manufacturing and assembly operations.

In some implementations, the enterprise (e.g., a company or corporation) may own and operate the manufacturing plants 204, 206, 208. In some implementations, the manufacturing plants 204, 206, 208 may be owned by a third party yet operated by the enterprise. In some implementations, the enterprise may own the manufacturing plants 204, 206, 208 and a third party may operate them.

The enterprise (e.g., a company) can have a central location 202 (e.g., a headquarters) and various manufacturing plants 204, 206, 208 at different geographic locations (e.g., the manufacturing plants may be located in a different town, city, county, state or country from the central location or from one another). The central location 202 can include a central computer device 210. The central computer device 210 can maintain a BOM for a product type manufactured at one of the manufacturing plants. The manufacturing plants 204, 206, 208 can include manufacturing computer devices 212, 214, 216 respectively. The manufacturing computer devices 212, 214, 216 can include local MRP modules 220, 222, 224 respectively.

In some implementations, the product manufacturing enterprise system 200 can determine where suppliers (e.g., vendors that supply materials and parts to the enterprise for the assembly and manufacture of finished products) are geographically located relative to a manufacturing plant. The product manufacturing enterprise system 200 can use geographic-allocation criterion (e.g., a geographic location factor) to assign responsibilities for each supplier to a manufacturing plant that is located geographically close to the supplier. In some implementations, the central location 202 can include manufacturing capabilities and can be included with the manufacturing plants in determining the geographical based assignment of suppliers.

In some implementations, the product manufacturing enterprise system 200 can use a geographical based source of supply as criterion to structure a material requirements planning process. The product manufacturing enterprise system 200 can determine where suppliers are geographically located. The product manufacturing enterprise system 200 can assign the responsibility for the managing and purchasing of parts from a supplier to a manufacturing plant that is geographically located close to the supplier. The product manufacturing enterprise system 200 can divide the management of the materials and parts included in a BOM by a supply chain structure (e.g., location of a supplier relative to a manufacturing plant).

For example, the central location 202 can supply a BOM to each of the manufacturing plants 204, 206, 208. The local MRP module 220 in manufacturing computer device 212 in manufacturing plant 204 can perform a BOM explosion using the geographic-allocation criterion. The geographic-allocation criterion can be geographic information used to define the criterion a supplier can meet in order for the product manufacturing enterprise system 200 to assign responsibility for the supplier to a particular manufacturing plant. For example, the geographic information can be a zone that defines a set radius, measured in miles or kilometers from a manufacturing plant or the geographic location of the manufacturing plant (e.g., a country, region, county, state, city or town). In another example, the geographic information can be a zone that defines a distance traveled, measured in miles or kilometers, from a manufacturing plant to a supplier using one or more modes of travel. The modes of travel can be by land (e.g., road travel by truck, rail travel by train), by water (e.g., cargo boats), or by air (e.g., cargo planes).

For example, the local MRP module 220 in the manufacturing computer device 212 in manufacturing plant 204 can perform a BOM explosion that will include all of the materials and parts that are the responsibility of the manufacturing plant 204 based on supplier met geographic-allocation criterion. The manufacturing plant 204 can be responsible for the management and procurement of all materials and parts from specific suppliers assigned to it that meet the geographic-allocation criterion.

In some implementations, the BOM can include geographical tags used in the explosion process to identify which manufacturing plant is responsible for the management and procurement of the specific part based on the geographic-allocation criterion. For example, the product manufacturing enterprise system 200 can define a geographical tag for the supply source for a component in the master data for the BOM either directly or indirectly. Additionally, the product manufacturing enterprise system 200 can define a geographical tag for each manufacturing plant (e.g., manufacturing plants 204, 206, 208) and for the central location 202 in a BOM position variant. The geographic-allocation criterion can be defined to minimize the distance between the supply source and the manufacturing plant or central location responsible for the supply source, using the respective geographical tags. For example, in a preprocessing step performed prior to a BOM explosion, the product manufacturing enterprise system 200 can determine the distance from each manufacturing plant and the central location to the supply source for a component for each BOM material component position. The product manufacturing enterprise system 200 can assign the supply source for the component to the manufacturing plant or central location that meets the geographic-allocation criterion (e.g., the manufacturing plant or central location geographically closest to the supply source). The master MRP module 130 can explode only the components of the BOM for suppliers that meet the geographic-allocation criterion for the central location (e.g., supply sources geographically closest to the central location). A local MRP module can explode only the components of the BOM for suppliers that meet the geographic-allocation criterion for the particular manufacturing plant associated with the local MRP module (e.g., supply sources geographically closest to the manufacturing plant).

In some implementations, the product manufacturing enterprise system 200 can assign a geographical based source of supply to a BOM position variant in an indirect way. For example, master data for a supplier can include a first geographical tag, and purchasing objects can connect a material number with the supplier master data. The product manufacturing enterprise system 200 can also assign the material number to a BOM position variant. Additionally, the product manufacturing enterprise system 200 can assign a second geographical tag to the BOM position variant that can represent the manufacturing plant responsible for the supplier of the component. A local MRP module in a manufacturing plant can explode the BOM using the geographic-allocation criterion. The local MRP module can explode only the components of the BOM for suppliers that meet the geographic-allocation criterion for the particular manufacturing plant the can supply the finished product.

For example, the manufacturing plant 204 can produce a partial planned order for a finished product based on the exploded BOM produced by the local MRP module 220. The partial planned order can include the materials and parts the manufacturing plant 204 can source based on the suppliers identified as meeting the geographic-allocation criterion for the manufacturing plant 204. Each manufacturing plant 204, 206, 208 can produce a partial planned order based on the local MRP module 220, 222, 224, respectively, explosion of the BOM for a finished product. The explosion of the BOM for the finished product can include identified materials and parts that each manufacturing plant 204, 206, 208 can source for the product based on the parts that suppliers who fulfilled the geographic-allocation criterion can provide. Each partial planned order can be uploaded from each manufacturing plant 204, 206, 208 to the central computer device 210 using a service 226 in the SOA. In some implementations, the central location 202 can request (e.g., “pull”) a partial planned order from each manufacturing plant 204, 206, 208. In some implementations, the manufacturing plants 204, 206, 208 can send (e.g., “push”) each partial planned order to the central location.

In some implementations, the central computer device 210 can assemble all of the partial planned orders from the manufacturing plants into a complete planned order for a finished product (e.g., complete planned order 218). For example, an MRP module explosion of the master data for a BOM can be a product oriented complete planned order 218. The complete planned order 218 shows a list 238, 240, 242 of the components supplied by each manufacturing plant 204, 206, 208 respectively. One or more of the suppliers for which each manufacturing plant 204, 206, 208 is responsible can supply one or all of the components for the finished product. The complete planned order 218 can represent a view of the master data for the BOM for a finished product as a list 238, 240, 242 of materials and parts based on the identified supply chain that can be manufactured at a particular manufacturing plant 204, 206, 208 respectively.

The product manufacturing enterprise system 200 can use the complete planned order 218 to manufacture a product at manufacturing plant 204. The product oriented complete planned order 218 can list components for the finished product according to the manufacturing plant responsible for supplying the component. The product manufacturing enterprise system 200 can produce a product oriented complete planned order for a finished product manufactured at each of the manufacturing plants (e.g., complete planned order 218 for manufacturing plant 204, complete planned order 228 for manufacturing plant 206 and complete planned order 230 for manufacturing plant 208). The central computer device 210 can send the complete planned orders 218, 228, 230 to the respective manufacturing plants 204, 206, 208 using services 232, 234, 236 from the SOA respectively. The central location 202 can manage the complete planned order for a finished product while the manufacturing plants 204, 206, 208 can manage the purchasing of the specific parts for the finished product from the suppliers identified as the manufacturing plant's responsibility. In some implementations, a purchasing manager at a manufacturing plant can be responsible for all of the materials and parts sourced from each of the suppliers that meet the geographic-allocation criterion for the manufacturing plant.

In some implementations, the central location 202 can manage the complete planned orders for each finished product manufactured by the product manufacturing enterprise system 200. A complete planned order object can be stored in the central location 202 where each complete planned order object includes a complete planned order used in the manufacture of a finished product. The central location 202 can provide each complete planned order object to the respective manufacturing plant. In some implementations, the manufacturing plant can request the complete planned order object from the central location 202. The manufacturing plant can use the complete planned order object to manufacture the finished product.

In some implementations, the manufacturing plant (e.g., manufacturing plant 204) can store the complete planned order objects in the manufacturing computer device (e.g., manufacturing computer device 112). In some implementations, the manufacturing plant (e.g., manufacturing plant 204) can store the complete planned order objects on a central computer device (e.g., central computer device 210) in a central location (e.g., central location 202). The manufacturing plant (e.g., manufacturing plant 204) can access the planned order objects when the manufacture of the finished product is performed.

In the product manufacturing enterprise system 200, changes to the manufactured finished products can occur prior to the manufacture of the finished product but after the receipt of the initial order for the product. For example, an engineering change notice can be introduced into the product manufacturing enterprise system 200 indicating the product order (e.g., using a product order number) and changes requested for the finished product. The changes may affect the parts needed for the manufacture of the finished product.

In some implementations, the central location 202 can receive the engineering change notice. The central computer device 210 can update the master data for the BOM to reflect the change. The central computer device 210 can supply an updated BOM to the manufacturing plant responsible for the procurement of the changed part (e.g., manufacturing plant 206). The manufacturing plant 206 can update its partial planned order for the finished product and send it back to the central computer device 210. The central computer device 210 can update the complete planned order using the updated partial planned order. The central computer device 210 can send the updated complete planned order to the manufacturing plant responsible for the assembly and manufacture of the finished product (e.g., manufacturing plant 204). In some implementations, the manufacturing plant responsible for the parts procurement for the changed part can be the same manufacturing plant that assembles and manufactures the finished product. The change can also be made to the complete planned order object to be reflected in the manufacture of the finished product.

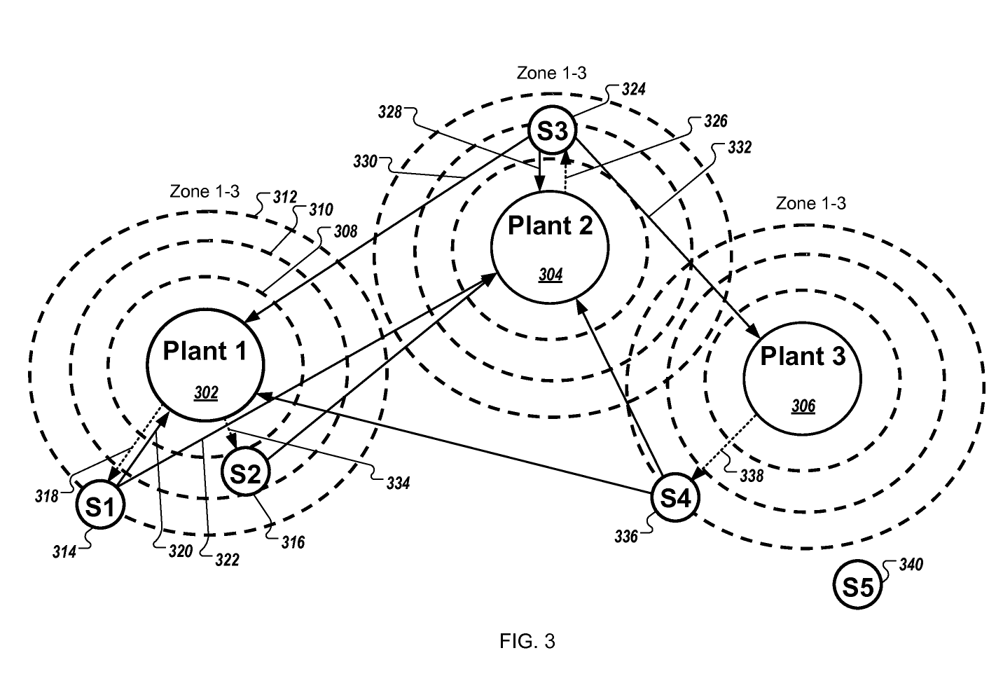

FIG. 3 schematically illustrates an exemplary process for determining component procurement at a manufacturing plant level. Using FIG. 2 as an example, the product manufacturing enterprise system 200 can base component procurement for a finished product on the geographic location of a supplier in relation to a manufacturing plant (e.g., a geographic location factor). The manufacturing plant can be responsible for the management and procurement of components from suppliers located within a designated zone relative to the manufacturing plant.

In some implementations, the product manufacturing enterprise system 200 in the example of FIG. 2 can define a zone as a geographic boundary that surrounds a manufacturing plant. For example, using a manufacturing plant 302 as a starting point, the product manufacturing enterprise system 200 can define a zone (e.g., zone 308) around the manufacturing plant as a radial distance from the manufacturing plant. Multiple zones (e.g., zones 308, 310, 312) can be combined around the manufacturing plant 302 where each zone adds a specific distance from the manufacturing plant 302 to an outside boundary. For example, zones 308, 310, 312 surround manufacturing plant 302 where zone 308 can define a 100 kilometer (km) radial boundary from the manufacturing plant 302, zone 310 can define a 200 km radial boundary from the manufacturing plant 302, and zone 312 can define a 300 km radial boundary from the manufacturing plant 302.

In some implementations, a zone can be a predefined geographic boundary such as a country, a region (e.g., the northeastern United States, Southeast Asia, etc.), a state, a county, a town or a city in which the manufacturing plant can be located. For example, a manufacturing plant in the state of Connecticut in the United States can be responsible for the procurement of components from suppliers located in a geographic region defined as the Northeastern United States, which includes the state of Connecticut.

The product manufacturing enterprise system 200 can combine the designated zone that includes the manufacturing plant with a list of suppliers. The manufacturing plant can manage the parts procurement from suppliers that are located within the zone that includes the manufacturing plant. For example, a purchasing manager at the manufacturing plant can be responsible for all purchases made with a particular supplier. The purchasing manager in the manufacturing plant can keep the responsibility for parts sourcing and purchasing at a local level. Due to the proximity of the manufacturing plant to the supplier, the purchasing manager can visit the supplier to negotiate component purchases (e.g., pricing, delivery, etc.) and to check on the quality control for the procured parts. For example, if the product manufacturing enterprise system 200 determines that a manufacturing plant in France can be responsible for one or more suppliers located in France, the French purchasing manager at the manufacturing plant in France can speak the local language (e.g., French) which can simplify and improve supplier interactions.

As described with reference to the example in FIG. 2, a local MRP module (e.g., local MRP module 220) included in a manufacturing computer device (e.g., manufacturing computer device 212) can perform a BOM explosion for the finished product for the manufacturing plant (e.g., manufacturing plant 204). The exploded BOM can include the identified materials and parts that the manufacturing plant (e.g., manufacturing plant 204) can source from suppliers that are located within the defined zone for the manufacturing plant.

For example, a product manufacturing enterprise system (e.g., product manufacturing enterprise system 200) can determine that supplier 314 is located within a defined zone (e.g., zone 1-3) surrounding the manufacturing plant 302. The manufacturing plant 302 can manage the purchasing 318 (e.g., the release of a purchase order for parts to a supplier or vendor) of parts from supplier 314 that may be needed by the manufacturing plants in the product manufacturing enterprise system. The manufacturing plant 302 can consolidate the purchase order to the supplier 314 for all identical parts needed by the manufacturing plants in the product manufacturing enterprise system, taking advantage of discounted volume pricing.

Additionally, the manufacturing plant 302 can specify the quantity of parts to deliver to each of the manufacturing plants in the product manufacturing enterprise system that can use the part in order to assemble and manufacture finished products at the manufacturing plant. For example, the manufacturing plant 302 can indicate to the supplier 314 the number of purchased parts the supplier 314 can physically ship 320, 322 to the manufacturing plant 302 and to manufacturing plant 304, respectively, where the manufacturing plants 302, 304 can use the parts in the assembly and manufacture of finished products. In this example, two of the three manufacturing plants (manufacturing plant 302 and manufacturing plant 304) use the parts sourced by supplier 314. The supplier 314 may not ship any parts to the manufacturing plant 306.

In another example, the product manufacturing enterprise system (e.g., product manufacturing enterprise system 200) can determine that supplier 316 is also located within a defined zone (e.g., zone 1-3) surrounding the manufacturing plant 302. The manufacturing plant 302 can manage the purchasing 334 of parts from supplier 316 that may be needed by the manufacturing plants in the product manufacturing enterprise system. The manufacturing plant 302 can consolidate the purchase order to the supplier 316 for all identical parts needed by the manufacturing plants in the product manufacturing enterprise system, taking advantage of discounted volume pricing. Manufacturing plant 304 is the only manufacturing plant that needs the parts sourced from supplier 316 and managed by manufacturing plant 302. Therefore, a first plant can manage the procurement of parts for a second plant where the first plant may not use the parts for the assembly and manufacture of products in the first plant.

In another example, a product manufacturing enterprise system (e.g., product manufacturing enterprise system 200) can determine that supplier 324 is located within a defined zone (e.g., zone 1-3) surrounding manufacturing plant 304. The manufacturing plant 304 can manage the purchasing 326 of parts from supplier 324 that may be needed by the manufacturing plants in the product manufacturing enterprise system. The manufacturing plant 304 can consolidate the purchase order to the supplier 324 for all identical parts needed by the manufacturing plants in the product manufacturing enterprise system, taking advantage of discounted volume pricing. In this example, manufacturing plants 302, 304, 306 can use the parts sourced by the supplier 324 in the assembly and manufacture of finished products where the manufacturing plant 304 manages the procurement of the parts.

Additionally, the manufacturing plant 304 can specify the quantity of parts to deliver to each of the manufacturing plants 302, 304, 306. For example, the manufacturing plant 304 can indicate to the supplier 324 the number of purchased parts the supplier 324 can physically ship 330, 328, and 332 to each manufacturing plant 304, 302, 306 respectively where the manufacturing plants 302, 304, 306 can use the parts in the assembly and manufacture of finished products.

In another example, a product manufacturing enterprise system (e.g., product manufacturing enterprise system 200) can determine that supplier 336 is located within a defined zone (e.g., zone 1-3) surrounding the manufacturing plant 306. The manufacturing plant 306 can manage the purchasing 338 of parts from supplier 336 that may be needed by the manufacturing plants in the product manufacturing enterprise system. The manufacturing plant 306 can consolidate the purchase order to the supplier 336 for all identical parts needed by the manufacturing plants in the product manufacturing enterprise system, taking advantage of discounted volume pricing. Manufacturing plant 306 may not use the parts sourced from supplier 336; however manufacturing plant 306 can manage the procurement of parts for manufacturing plants 302, 304.

In another example, supplier 340 may not be geographically located within any of the defined zones for the manufacturing plants 302, 304, 306. In some implementations, the supplier 340 can be managed by the manufacturing plant that is geographically closest to the supplier (e.g., manufacturing plant 306) even though the supplier 340 may not be located within the defined zone for the manufacturing plant. In some implementations, a central location (e.g., central location 202 in FIG. 2) in an enterprise can manage suppliers not located within a defined geographic zone for any of the manufacturing plants in the production manufacturing enterprise system.

In some implementations, all parts from a supplier may be shipped to the manufacturing plant that manages the supplier. The manufacturing plant itself may manage the shipment of the quantity of parts needed to assemble and manufacture finished products to each of the manufacturing plants that use the parts. For example, the production manufacturing enterprise system can use internal plant to plant shipments to get parts from one manufacturing plant to another.

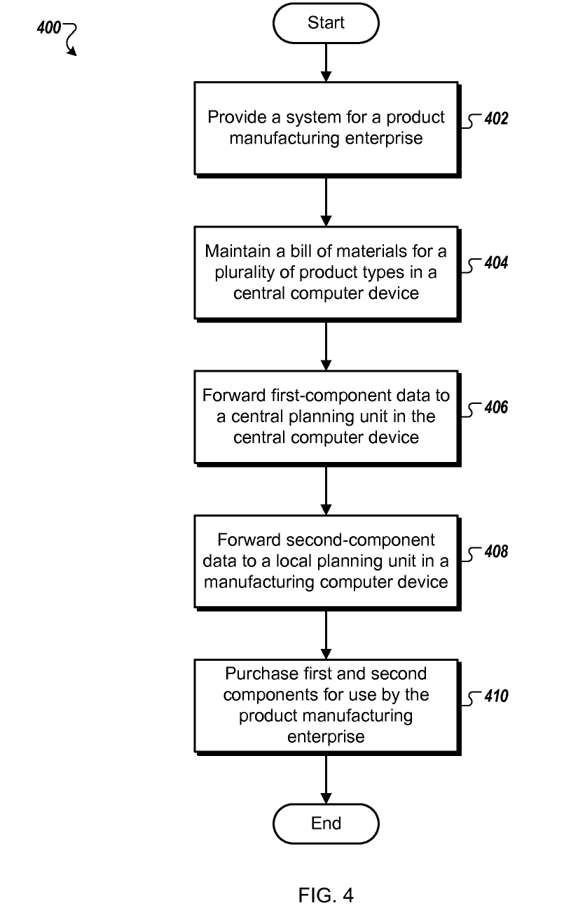

FIG. 4 is a flow chart of exemplary operations 400 that can be performed to manage planning of component requirements. For example, the exemplary product manufacturing enterprise system 100 of FIG. 1 can perform the operations 400. The operations 400 can be performed by a processor that executes instructions stored in a computer-readable medium. For example, a computer device operated by an enterprise can perform the operations 400.

A process begins at step 402 by providing a system for a product manufacturing enterprise. The product manufacturing enterprise system (e.g., product manufacturing enterprise system 100) can maintain a BOM for a plurality of product types in a central computer device in step 404. The BOM can include components that are common to a plurality of product types. The common components can be included in a platform and the product types can be based on a platform design, utilizing the platform along with additional components not included in the platform. For example, referring to FIG. 1, the product manufacturing enterprise system 100 can maintain the BOM 118 for a product type that can include a plurality of components including common components used for the platform and specific components not used in the platform.

The product manufacturing enterprise system can forward first-component data to a central planning unit in the central computer device in step 406. For example, referring to FIG. 1, the master MRP module 130 (e.g., a central planning unit) can perform a BOM explosion for the platform showing the common components used for the platform. The master MRP module 130 can generate a central plan for managing the planning and procurement of the common components for all product types manufactured by the enterprise.

The product manufacturing enterprise system can forward second-component data to a local planning unit in a manufacturing computer device in step 408. For example, referring to FIG. 1, the local MRP module 132 (e.g., a local planning unit) can perform a BOM explosion for the specific components showing the specific components which are not included in the platform. The local MRP module 120 can generate a local plan for managing the planning and procurement of the specific components for a product type manufactured by the enterprise.

First and second components for use by the product manufacturing enterprise can be purchased in step 410. For example, referring to FIG. 1, the product manufacturing enterprise system 100 can combine the central plan and the local plan to produce a complete plan. The product manufacturing enterprise system 100 can use the complete plan to purchase components for the assembly and manufacture of the product type. In some implementations, the purchase of components takes place over time and may not be performed in a single step as described in this example.

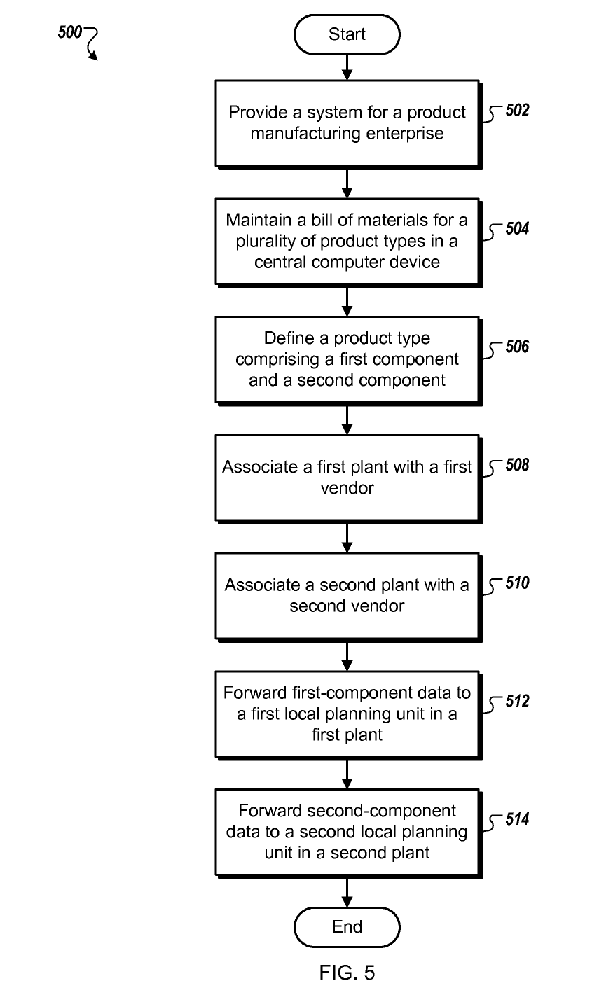

FIG. 5 is a flow chart of exemplary operations 500 that can be performed to manage planning of component requirements. For example, the exemplary product manufacturing enterprise system 200 of FIG. 2 can perform the operations 500. The operations 500 can be performed by a processor that executes instructions stored in a computer-readable medium. For example, a computer device operated by an enterprise can perform the operations 500.

A process begins at step 502 by providing a system for a product manufacturing enterprise. The product manufacturing enterprise system (e.g., product manufacturing enterprise system 200) can maintain a BOM for a plurality of product types in a central computer device in step 504. One or more suppliers or vendors at various geographic locations can source the components included in the BOM. For example, referring to FIG. 2, the complete planned order 218 can be a view of the BOM for a product type that shows the components used for the assembly and manufacture of the product type listed by an internal source of supply (e.g., a manufacturing plant in the enterprise).

The process continues in step 506 by defining a product type comprising a first component and a second component. For example, referring to FIG. 2, the complete planned order 218 can be a view of the BOM for a product type that shows the defined components comprising the product type. The product manufacturing enterprise system (e.g., product manufacturing enterprise system 200) can associate a first plant with a first vendor in step 508. For example, as described with reference to FIG. 2 and FIG. 3, the product manufacturing enterprise system 200 can use geographic-allocation criterion to associate a manufacturing plant with a vendor. The manufacturing plant can be responsible for all vendor interactions including component purchases for all product types assembled and manufactured by the enterprise. The product manufacturing enterprise system (e.g., product manufacturing enterprise system 200) can associate a second plant with a second vendor in step 510.

In step 512, first-component data can be forwarded to a first local planning unit in a first plant. For example, referring to FIG. 2, the central computer device 210 in the central location 202 can forward a BOM that includes first-component data to manufacturing plant 204. The local MRP module 220 (e.g., a local planning unit) can perform a BOM explosion that will include all of the components that are the responsibility of the manufacturing plant 204. The manufacturing plant 204 can produce a partial planned order for the product type based on the exploded BOM produced by the local MRP module 220. The partial planned order can include the components the manufacturing plant 204 can source based on the suppliers identified as meeting the geographic-allocation criterion for the manufacturing plant 204.

In step 514, second-component data can be forwarded to a second local planning unit in a second plant. For example, referring to FIG. 2, the central computer device 210 in the central location 202 can forward a BOM that includes second-component data to manufacturing plant 206. The local MRP module 222 (e.g., a local planning unit) can perform a BOM explosion that will include all of the components that are the responsibility of the manufacturing plant 206. The manufacturing plant 206 can produce a partial planned order for the product type based on the exploded BOM produced by the local MRP module 222. The partial planned order can include the components the manufacturing plant 206 can source based on the suppliers identified as meeting the geographic-allocation criterion for the manufacturing plant 206.

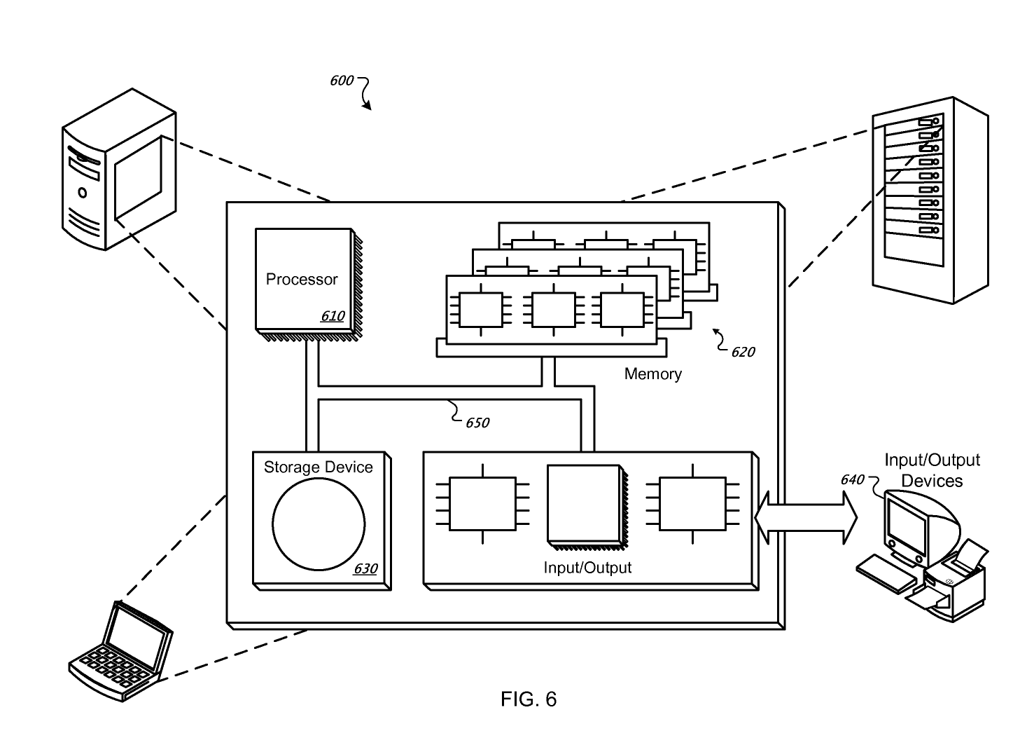

FIG. 6 is a schematic diagram of a generic computer system 600. The system 600 can be used for the operations described in association with any of the computer-implement methods described previously, according to one implementation. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. The memory 620 is a volatile memory unit in some implementations and is a non-volatile memory unit in other implementations.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer program product tangibly embodied in a computer-readable storage medium and comprising instructions that when executed by a processor perform a method for managing planning of component requirements, the method comprising:
providing a system for a product manufacturing enterprise having a central location and multiple manufacturing plants at different locations, the system comprising a central computer device at the central location and respective manufacturing computer devices for each of the multiple manufacturing plants;
maintaining, in the central computer device, a BOM for a plurality of product types manufactured at the multiple manufacturing plants, the BOM defining that each of the product types belongs to a platform design and comprises at least (i) a first component common to all of the products types and (ii) a second component not common to all of the product types;
forwarding, from the BOM, first-component data regarding the first component of the product types to a central planning unit in the central computer device, the central planning unit being configured to generate a central plan for managing planning for the first component;
forwarding, from the BOM, second-component data regarding the second component of each of the product types to local planning units in the manufacturing computer devices, each of the local planning units being configured to generate a local plan for managing planning for the second component used by the corresponding manufacturing plant; and
causing the first and second components to be purchased for use by the product manufacturing enterprise according to the central plan and the local plan.

2. The computer program product of claim 1, further comprising applying a filter in the central computer device to select the first-component data and the second-component data from the BOM.

3. The computer program product of claim 1, further comprising providing the central plan to the manufacturing computer devices, wherein each of the manufacturing computer devices combines the central plan with the local plan from the manufacturing computer device.

4. The computer program product of claim 3, wherein the central computer device pushes the central plan to at least one of the manufacturing computer devices.

5. The computer program product of claim 3, wherein at least one of the manufacturing computer devices pulls the central plan from the central computer device.

6. The computer program product of claim 3, wherein the central computer device comprises a service-oriented architecture, and wherein the central plan is provided to the manufacturing computer devices using a service in the service-oriented architecture.

7. The computer program product of claim 3, wherein each of the manufacturing computer devices generates an object using the central plan and the local plan, and uses the object in executing manufacturing of at least one of the product types by the manufacturing computer system.

8. The computer program product of claim 7, wherein engineering changes are received from at least one of the central planning unit and the manufacturing planning unit, and wherein the object is modified according to the engineering changes.

9. A computer program product tangibly embodied in a computer-readable storage medium and comprising instructions that when executed by a processor perform a method for managing planning of component requirements, the method comprising:
providing a system for a product manufacturing enterprise having a central location and multiple manufacturing plants at different locations, the system comprising a central computer device at the central location and respective manufacturing computer devices for each of the multiple manufacturing plants;
maintaining, in the central computer device, a BOM for at least one product type manufactured at the multiple manufacturing plants, the BOM defining that the product type comprises at least (i) a first component delivered from a first vendor and (ii) a second component delivered from a second vendor;
associating a first plant of the manufacturing plants with the first vendor based on a location of the first vendor and a geographic-allocation criterion;
associating a second plant of the manufacturing plants with the second vendor based on a location of the second vendor and the geographic-allocation criterion;
forwarding, from the BOM, first-component data regarding the first component to a first local planning unit in the manufacturing computer device of the first plant, the first local planning unit being configured to generate a first central plan for managing planning for the first component on behalf of all of the manufacturing plants; and
forwarding, from the BOM, second-component data regarding the second component to a second local planning unit in the manufacturing computer device of the second plant, the second local planning unit being configured to generate a second central plan for managing planning for the second component on behalf of all of the manufacturing plants.

10. The computer program product of claim 9, wherein the geographic-allocation criterion comprises that the first plant is selected for the first vendor because the first vendor is located geographically closer to the first plant than the second plant.

11. The computer program product of claim 9, further comprising providing the BOM with geographical tags for the first-component data and the second-component data, the geographical tags representing the first and second plants, respectively.

12. The computer program product of claim 9, wherein the BOM includes at least a first view representing the product type being manufactured at the first plant, and a second view representing the product type being manufactured at the second plant.

13. The computer program product of claim 12, further comprising receiving, at the central computer device, the first and second central plans from the first and second planning units, respectively.

14. The computer program product of claim 12, further comprising forwarding, from the central computer device and to each of the manufacturing computer devices of the first and second plants, first and second finished order objects configured for use by the first and second manufacturing computer devices, respectively, in executing production of the product type.

15. The computer program product of claim 14, wherein the first finished order object requires the product type to be manufactured using a component for which the planning is managed by the manufacturing computer device of the second plant.

16. A system comprising:
a central computer device at a central location of a product manufacturing enterprise, the central computer device having stored therein a BOM defining a product manufactured by the product manufacturing enterprise as comprising at least first and second components;
manufacturing computer devices connected to the central computer device and operated by manufacturing plants at different locations of the product manufacturing enterprise; and
planning units tangibly embodied in computer readable storage media distributed within the system, each of the planning units configured to generate a plan for managing planning for at least one of the first and second components;
wherein the system dynamically distributes, among the planning units and based on at least one criterion, the planning for the first and second components for manufacturing the product.

17. The system of claim 16, wherein the criterion includes a factor of which of the manufacturing computer devices uses the respective first and second components.

18. The system of claim 16, wherein the criterion includes a geographic location factor.

19. The system of claim 18, wherein the geographic location factor comprises that one of the planning units that is closest to a vendor for the first component shall perform the planning for the first component, and that one of the planning units that is closest to a vendor for the second component shall perform the planning for the second component.

20. The system of claim 18, wherein one of the planning units is located in the central computer system.
